(19) United States
(12) Patent Application Publication
(10) Pub. No.: US 2025/0323528 A1
(43) Pub. Date: Oct. 16, 2025

(54) BATTERY OPERATED VEHICLE LIFT WITH WIRELESS CHARGING

(71) Applicant: Gray Manufacturing Company, Inc., St. Joseph, MO (US)

(72) Inventors: David Emmendorfer, Cosby, MO (US); Stephen J. Rucker, Savannah, MO (US)

(21) Appl. No.: 18/633,247

(22) Filed: Apr. 11, 2024

(51) Int. Cl. H02J 50/12; B66F 3/44; B66F 3/46; H02J 7/00; H02J 50/00; H02J 50/40; H02J 50/90

(52) U.S. Cl. CPC H02J 50/12; B66F 3/44; B66F 3/46; H02J 7/0013; H02J 7/0042; H02J 50/005; H02J 50/40; H02J 50/90

(57) ABSTRACT

A vehicle lift system broadly comprising a vehicle lift and a wireless charger. The vehicle lift includes a wireless charging system comprising a battery configured to provide electrical power to the vehicle lift and a power receiver electrically coupled with the battery. The wireless charger comprises a power transmitter configured to transmit electrical power to the power receiver via magnetic resonance. The power transmitter is movable between a first position and a second position for transmitting the electrical power in the second position.

### BACKGROUND

### 1. Field of the Invention

The present invention relates generally to vehicle lift systems. More particularly, the invention concerns a battery-operated vehicle lift system configured for wireless charging.

### 2. Description of the Prior Art

The need to lift a vehicle from the ground for service work is well established. For instance, it is often necessary to lift a vehicle for tire rotation or replacement, steering alignment, oil changes, brake inspections, exhaust work, and other automotive maintenance. Traditionally, lifting a vehicle has been accomplished through the use of equipment that is built-into a service facility, such as either lift units with hydraulic actuator(s) installed below the surface of the floor or two and four-post type lift systems installed on the floor surface. These built-in units are located at a fixed location at the service facility and adapted to engage a vehicle frame to lift the vehicle from the ground.

In an effort to increase the versatility and mobility of lift devices and to reduce the need to invest in permanently mounted lifting equipment, devices commonly known as mobile column lifts have been developed. A vehicle lift system may include several lifts each including its own electrical power supply system having one or more batteries for providing power to the lift's electronic control system and lift mechanisms. Generally, the batteries of the electrical power supply system require frequent charging, so as to maintain sufficient charge to provide continued functionality of the lift throughout a working day. However, it can be difficult keep the lift physically coupled with a standard recharging power source, such as a mains power outlet, because the lift is mobile and may be used in locations out of range of such standard recharging power sources. Furthermore, in some instances, the electrical cords generally used to electrically connect recharging power sources with the lift may interfere with the operation and/or mobility of the lift, or may otherwise interfere with the maintenance being performed on the vehicle being raised by the lift.

Wireless charging allows for a lift to be continuously charged while the lift is out of range of a physical recharging power source or when it is otherwise impractical to use a physical recharging power source. Certain types of wireless power transfer systems have been used in the past such as induction charging systems, but they have certain limitations. For example, wireless chargers within a charging space may be a hindrance when not in use. By the same token, wireless chargers in less intrusive positions may not provide optimal charging.

As such, there is a need for a vehicle lift system configured to provide wireless charging to a lift such that the batteries of the lift can be sufficiently and conveniently charged yet the wireless chargers are less intrusive when not being used for charging.

### SUMMARY OF THE INVENTION

In one embodiment of the present invention, there is provided a vehicle lift system broadly comprising a vehicle lift and a wireless charger. The vehicle lift comprises a base, a carriage, a lift actuator, and a wireless charging system. The carriage is configured to receive a wheel of a vehicle to be lifted. The lift actuator is configured to vertically raise and lower the carriage and hence the wheel relative to the base. The wireless charging system comprises a battery configured to provide electrical power to the vehicle lift and a power receiver electrically coupled to the battery. The wireless charger comprises a power transmitter configured to transmit electrical power to the power receiver via magnetic resonance. The power transmitter is movable between a first position and a second position for transmitting the electrical power in the second position.

In another embodiment of the present invention, there is provided a vehicle lift system broadly comprising a vehicle lift and a wireless charger. The vehicle lift comprises a base, a carriage, a lift actuator, and a wireless charging system. The base is configured to traverse a floor. The carriage is configured to receive a wheel of a vehicle to be lifted. The lift actuator is configured to vertically raise and lower the carriage and hence the wheel relative to the base. The wireless charging system comprises a battery configured to provide electrical power to the vehicle lift and a power receiver electrically coupled to the battery. The wireless charger comprises a power transmitter embedded in the floor and configured to transmit electrical power to the power receiver via magnetic resonance upward through the floor.

In another embodiment of the present invention, there is provided a method of wirelessly providing power to a vehicle lift of a vehicle lift system. The method broadly comprises a step of mounting a power transmitter of a wireless charger of the vehicle lift system on a ceiling in a charging space. The method further comprises a step of positioning the vehicle lift within the charging space below the power transmitter. The method further comprises a step of moving the power transmitter from a first position to a second position. The method further comprises a step of wirelessly transmitting the electrical power via magnetic resonance from the power transmitter to a power receiver of the vehicle lift.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWINGS

FIG. 1 is a perspective environmental view of a vehicle lift system constructed in accordance with an embodiment of the invention;

FIG. 2 is a perspective view of a vehicle lift of the vehicle lift system of FIG. 1;

FIG. 3 is a schematic diagram of certain components of a control system of the vehicle lift of FIG. 2;

FIG. 4 is a schematic diagram of certain components of a wireless charging system of the vehicle lift of FIG. 2;

FIG. 5 is a flow diagram of certain method steps of wirelessly providing power to a vehicle lift in accordance with another embodiment of the invention;

FIG. 6 is a perspective environmental view of a wireless charger constructed in accordance with another embodiment of the invention;

FIG. 7 is a perspective environmental view of a wireless charger constructed in accordance with another embodiment of the invention; and

FIG. 8 is a perspective environmental view of a wireless charger constructed in accordance with another embodiment of the invention.

### DETAILED DESCRIPTION OF EMBODIMENTS

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

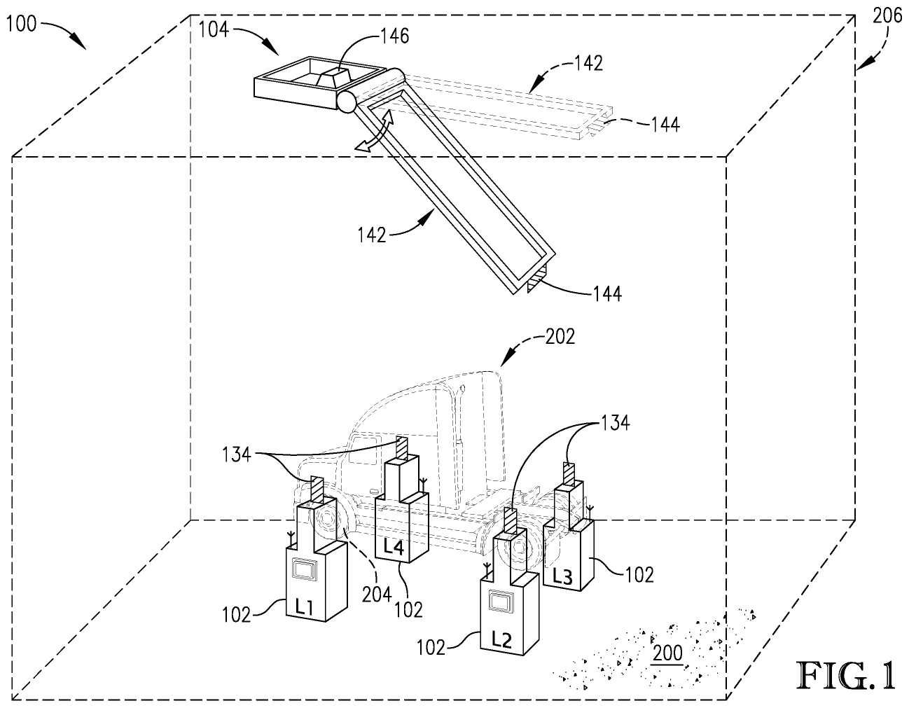

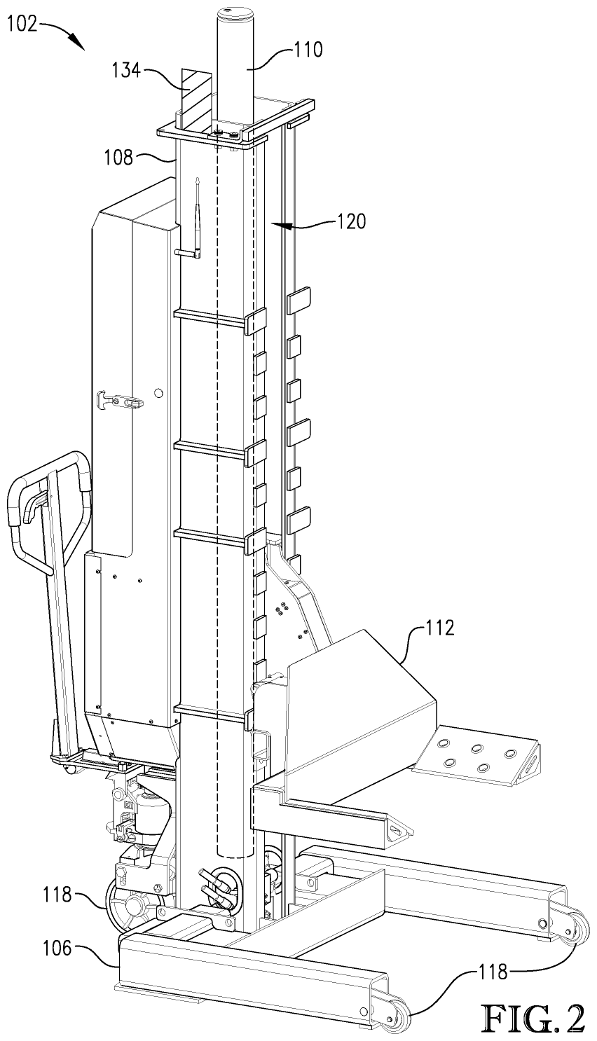

Turning to FIGS. 1-4, a vehicle lift system 100 constructed in accordance with an embodiment of the invention broadly comprises one or more individual vehicle lifts 102 and one or more wireless chargers 104.

The vehicle lifts 102 may be substantially similar so only one vehicle lift 102 will be described in detail. The vehicle lift 102 broadly comprises a base 106, a post 108, a lift actuator 110, a carriage 112, a control system 114, and a wireless charging system 116.

The base 106 supports the vehicle lift 102 on a floor surface 200 or ground. The base 106 may include wheels 118 driven by a drive motor (not shown) for moving the vehicle lift 102 across the floor surface 200 and for positioning the vehicle lift 102 near a vehicle 202. The base 106 may have a horizontally large footprint to prevent the base 106 from tipping in any direction.

The post 108 may be rigidly coupled to the base 106 and extends upward therefrom. The post 108 supports the lift actuator 110 and may form a channel 120 configured to receive the lift actuator 110 therein and allow the lift actuator 110 to move up and down relative to the base 106.

The lift actuator 110 may be received in the channel 120 of the post 108 and may be operable to vertically raise and lower the carriage 112 relative to the base 106. The lift actuator 110 may be hydraulically, pneumatically, mechanically, and/or electrically driven.

The carriage 112 may be attached to the lift actuator 110 and may be configured to engage and support a wheel 204 of the vehicle 202. The carriage 112 may be vertically shiftable relative to the base 106 via the lift actuator 110 to raise the wheel 204 (and in some circumstances at least another portion of the vehicle 202).

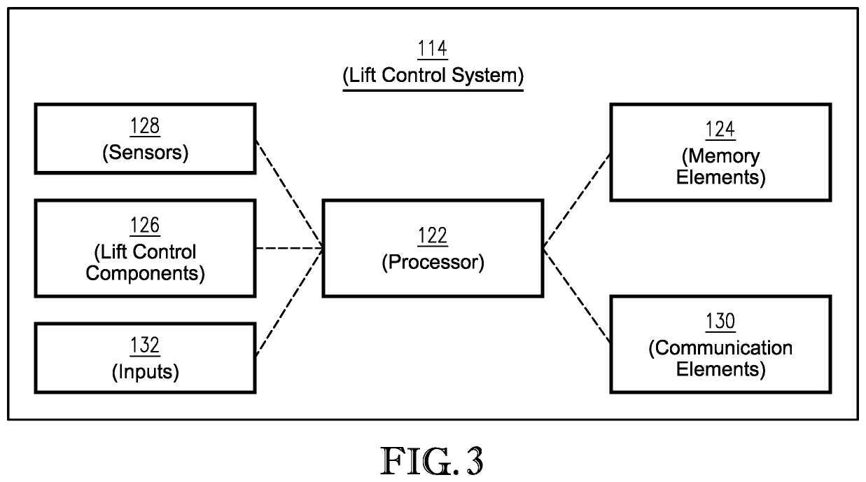

The control system 114 controls functionality of the vehicle lift 102 autonomously and/or in response to operator (i.e., user) commands. The control system 114 is illustrated schematically in FIG. 3 and may include a processor 122, a memory 124, one or more control components 126, one or more sensors 128, one or more communication elements 130, and one or more inputs 132.

The processor 122 may be configured to process lift instructions for its associated vehicle lift 102 (e.g., instructions for raising and lowering the carriage 112). For example, the processor 122 may be configured to process information relating to and for controlling the control components 126 and any of the sensors 128 associated with the vehicle lift 102. To that end, the processor 122 may be in communication with all of the various control components 126 (e.g., pumps, valves, etc.) and communication elements 130. Furthermore, it is contemplated that the processor 122 can control various types of lifts such as electrical (e.g., battery powered), mechanical (e.g., screw-type), hydraulic, and pneumatic-powered lifts.

In some embodiments, the processor 122 may be or may include a microprocessor, a microcontroller, a field programmable gate array, and the like, or combinations thereof. In some embodiments, the processor 122 may comprise a single-core, dual-core, or quad-core processor configured for simultaneously processing a plurality of different computer programs and/or applications. As such, the processor 122 may be operable to implement operating systems, and may generally be capable of executing computing programs, which are also commonly known as instructions, commands, software code, executables, applications, apps, and the like, which may all be stored on the memory 124.

The memory 124 may be capable of storing or retaining computer programs and may also store data, typically binary data, including text, databases, graphics, audio, video, combinations thereof, and the like. The memory 124 may be a non-transitory “computer-readable storage medium” and may include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof.

The control components 126 may include various components such as the lift actuator 110, a down-stop actuator, an emergency stop actuator, hydraulic and/or pneumatic valves, hydraulic and/or pneumatic pumps, and the like.

The sensors 128 may be communicatively connected to the processor 122 and may be strategically positioned about the vehicle lift 102 for sensing operational statuses, conditions, positions, proximities, and the like. To that end, the sensors 128 may include a height sensor, a pressure sensor, an energy status sensor, a velocity sensor, an actuator position sensor, a camera, a radar/lidar sensor, an RFID sensor, and the like.

The communication elements 130 may be configured to communicate via various networks and may include servers, routers, switches, wireless receivers, transmitters, antennas, and/or transceivers (e.g., Bluetooth or Wi-Fi), and the like, as well as electrically conductive cables and/or optical cables. The networks may be wired or wireless and may include local, metro, or wide area networks, as well as the Internet, Intranet, cloud networks, edge networks, and the like. Furthermore, the networks may include cellular or mobile phone networks, landline phone networks, public switched telephone networks, radio frequency (RF) networks, fiber optic networks, serial networks (e.g., USB), or the like. In the case of two or more vehicle lifts 102, the communication elements 130 of each of the vehicle lifts 102 may be configured to wirelessly send and receive signals from/to the other of the vehicle lifts 102 in the vehicle lift system 100 such that the wireless signals from/to the other vehicle lifts 102 such that the wireless signals can be used by the vehicle lifts 102 to coordinate raising/lowering a load (e.g., coordinate the heights of the carriage 112 during operation of the vehicle lifts 102.

The inputs 132 may be communicatively connected to the processor 122 and may receive operational commands from a user. To that end, the inputs 132 may comprise control inputs such as buttons, switches, knobs, or the like. Alternatively or additionally, the inputs 132 may comprise a touchscreen that presents virtual inputs and displays various operational information to the user.

Computer hardware components, such as the processor 122, memory 124, control components 126, sensors 128, communication elements 130, inputs 132, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in the memory 124. A further computer hardware component may then, at a later time, access the memory 124 to retrieve and process the stored output. Computer hardware components may also initiate communications with input or output devices, and may operate on a resource (e.g., a collection of information).

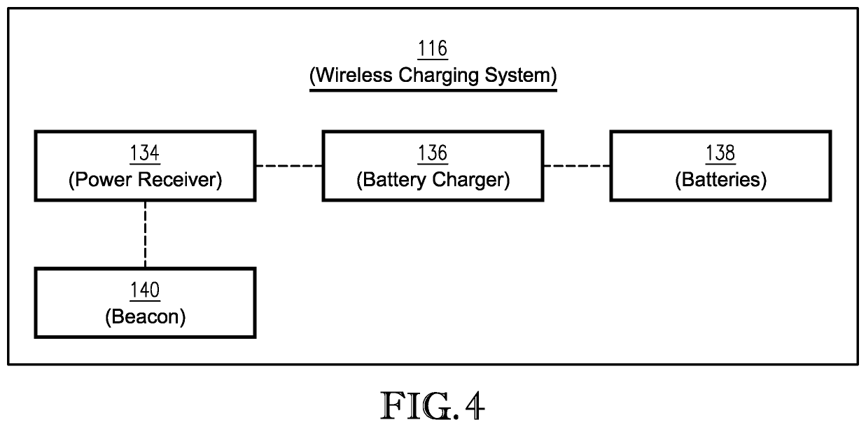

Turning to FIG. 4, the wireless charging system 116 stores electrical energy received from the wireless chargers 104 in a form usable on demand by the vehicle lift 102. The wireless charging system 116 broadly comprises a power receiver 134, a battery charger 136, one or more batteries 138. The wireless charging system 116 (and/or control system 114) may also include a beacon 140 for positioning one of the wireless chargers 104 near the vehicle lift 102.

The power receiver 134 may be configured to receive time-varying electromagnetic waves or signals. The power receiver 134 may be connected to the battery charger 136 for converting the time-varying electromagnetic waves or signals to electrical power storable by the batteries 138. To that end, the power receiver 134 may comprise an induction coil, a monopole antenna, a dipole antenna, or variations and/or combinations thereof. As specific examples, a monopole antenna may comprise metal rods, T antennas, inverted L antennas, umbrella antennas, or the like. A dipole antenna may include, for instance, a yagi-uda antenna, a log periodic antenna, a turnstile antenna, a corner reflector antenna, a patch antenna, or the like. In some embodiments, the power receiver 134 may comprise a directional antenna (i.e., a high-gain antenna) configured to receive electromagnetic waves over a relatively focused, narrow beam width. Such a directional antenna may comprise a parabolic antenna, a helical antenna, a yagi antenna, a phased array, and the like. The power receiver 134 may further include simple structures such as conductive coils (i.e., loop antennas), a rectangular or circular plate, or the like. In one embodiment, the power receiver 134 may be positioned near a top of the vehicle lift 102 for decreasing a power transmitting distance between the power receiver 134 and a power transmitter positioned above the vehicle lift 102. In another embodiment, the power receiver 134 may be positioned near a bottom of the vehicle lift 102 for decreasing a power transmitting distance between the power receiver 134 and a power transmitter positioned below the vehicle lift 102 (see floor-embedded embodiment described below).

The battery charger 136 may include various components necessary for conditioning the electromagnetic wave (i.e., an AC signal) received via the power receiver 134, such that the AC signal can be converted into a DC signal capable of charging the batteries 138. For example, the battery charger 136 may include a charge controller for conditioning the DC signal to a voltage and current suitable for storage in the batteries 138. The charge controller may comprise a rectifier configured for converting the AC signal received by the power receiver 134 into a DC signal. In some embodiments, the charge controller may further comprise one or more filters for assisting in providing a stabilized DC signal to the batteries 138. In still further embodiments, the battery charger 136 may include a voltage multiplier, such as a Villard cascade, to increase and/or scale the voltage level of the AC signal into a DC signal with a voltage level suitable for storage in the batteries 138. Furthermore, in some embodiments, the charge controller may include a switching regulator for converting the AC signal into a DC signal.

The batteries 138 may be configured to provide electrical power to the vehicle lift 102 and may be rechargeable via the wireless charging system 116. The batteries 138 may be Lead-Acid, Nickel-Cadmium, Nickel-Metal Hydride, Lithium Ion, Nickel-Zinc, Lithium-Ion Polymer, Alkaline, or a combination thereof. Certain battery types may be preferable, such as Lithium batteries which charge at much faster rates than Lead-Acid batteries, for example. In this way, the vehicle lift 102 may not need to stay near wireless chargers as long to charge the batteries 138. On the other hand, Lead-Acid batteries may be preferred particularly in applications where the vehicle lifts 102 can be near the wireless chargers 104 for extended periods of time.

The beacon 140 may be positioned on the vehicle lift 102 and configured to transmit a locating signal. The power transmitter 144 may be moved closer to the vehicle lift 102 (and/or the vehicle lift 102 may move closer to the power transmitter 144) based on the locating signal.

The wireless charging system 116 may be automated and may further comprise one or more processors and associated memories configured to perform various functions such as sensing the electrical power being received by the power receiver 134 and determining whether such power needs to be conditioned (e.g., increased and/or scaled) for storage in the batteries 138. In some embodiments, the wireless charging system 116 may be configured to obtain and utilize information from other components of the vehicle lift 102, such as the batteries 138, to determine when to begin charging the batteries 138, how long to charge the batteries 138, and how much electrical power should be used to charge the batteries 138. For instance, if the wireless charging system 116 determines that the charge of the batteries 138 has dropped below a predefined minimum level, the wireless charging system 116 may begin charging the batteries 138 via the electrical power received via the power receiver 134.

The wireless charging system 116 may also include a resonance control circuit for adjusting resonance of the power receiver 134 to match that of a power transmitter of one of the wireless chargers 104 described below. For instance, the wireless charging system 116 may include an LC circuit (i.e., an inductor and capacitor circuit), wherein properties of the inductor and/or capacitor of the resonance control circuit may be varied (e.g., via a variable capacitor) so as to form a variable tuned circuit. As such, the resonance control circuit can be adjusted to allow the resonance of the power receiver 134 to match the resonance of the power transmitter.

Turning again to FIG. 1, the wireless chargers 104 may be substantially similar so only one wireless charger 104 will be described in detail. The wireless charger 104 broadly comprises a movable support 142, a power transmitter 144 mounted on the movable support 142, and a transmitter actuator 146 configured to move the power transmitter 144 for improved wireless power transfer as explained in more detail below.

The movable support 142 may be attached or anchored to a ceiling or other overhead structure such as a frame or crane. The movable support 142 may be pivotable, rotatable, slideable, translatable, or otherwise deployable relative to the ceiling or other overhead structure, or a combination thereof. In one embodiment, the movable support 142 may be telescoping. In another embodiment, the movable support 142 may be suspended by cables configured to be unwound for lowering the movable support 142.

The transmitter actuator 146 may be operable to move the movable support 142 and hence the power transmitter 144 for improved wireless power transfer. In one embodiment, the transmitter actuator 146 may be configured to move the movable support 142 and hence the power transmitter 144 between a first position (e.g., a stowed position) and a second position (e.g., a deployed position) for the power transmitter 144 to transfer electrical power in the second position. In one embodiment, the first position is a retracted position and the second position is a downward extended position relative to the retracted position. The transmitter actuator 146 may be configured to automatically move the power transmitter 144 between the first position and the second position. In one embodiment, the transmitter actuator 146 may be configured to automatically move the power transmitter 144 between the first position and the second position upon receiving (or upon the power transmitter 144 receiving) a move signal from the power receiver 134 or another antenna of the vehicle lift 102, or in response to a signal from another sensor or another stimulus. Similarly, the transmitter actuator 146 may be configured to automatically move the power transmitter 144 from the second position to the first position upon receiving (or upon the power transmitter 144 receiving) a move signal. In this case, the move signal may indicate charging is complete. In an alternative embodiment, the transmitter actuator 146 may be omitted or bypassed such that the power transmitter 144 may be manually moved between the first position and the second position e.g., via handles or switches. The transmitter actuator 146 may be hydraulically, pneumatically, mechanically, and/or electrically driven. Other embodiments of a movable power transmitter in conjunction with a gantry system and a cable suspension system will be described in more detail below.

The power transmitter 144 may be or may be part of a charging pad mounted on the transmitter actuator 146 and configured to emit time-varying electromagnetic waves or signals. The power transmitter 144 may be connected to a power source, such as mains power, and may be configured to convert the electrical power from the power source into a time-varying electromagnetic wave. To that end, the power transmitter 144 may comprise an induction coil, a monopole antenna, a dipole antenna, or variations and/or combinations thereof. As specific examples, a monopole antenna may comprise metal rods, T antennas, inverted L antennas, umbrella antennas, or the like. A dipole antenna may include, for instance, a yagi-uda antenna, a log periodic antenna, a turnstile antenna, a corner reflector antenna, a patch antenna, or the like. In some embodiments, the power transmitter 144 may comprise a directional antenna (i.e., a high-gain antenna) configured to transmit electromagnetic waves over a relatively focused, narrow beam width. Such a directional antenna may comprise a parabolic antenna, a helical antenna, a yagi antenna, a phased array, and the like. The power transmitter 144 may further include simple structures such as conductive coils (i.e., loop antennas), a rectangular or circular plate, or the like. In some embodiments, the power transmitter 144 may be the same type of antenna as the power receiver 134. The power transmitter 144 may be particularly configured to transmit electrical power downward to the power receiver 134. The power receiver 134 may be positioned uniformly relative to other power receivers 134 in the case where the vehicle lifts 102 are all the same height. Furthermore, power receivers 134 may be mounted throughout a shop to charge vehicle lifts 102 in different locations.

The above-described wireless charging system 116 and wireless chargers 104, and other charging systems described herein may utilize resonant charging, which uses electromagnetic induction to transfer power. To that end, the power receiver 134 and the power transmitter 144 may be tuned to a common resonant frequency. Resonant charging allows more flexibility in placement of the power transmitter 144 and the power receiver 134. For example, the power transmitter 144 and the power receiver 134 do not need to be precisely aligned. The power transmitter 144 and the power receiver 134 can also be separated by a much larger distance and still charge at high currents. Furthermore, multiple vehicle lifts can simultaneously be charged from one power transmitter 144 and do not have to charge at the same rate. Resonant charging also allows faster charge rates than conventional induction charging. Resonant charging also provides safety benefits. For example, metal objects can be placed on such a power transmitter 144 without being heated to unsafe temperatures.

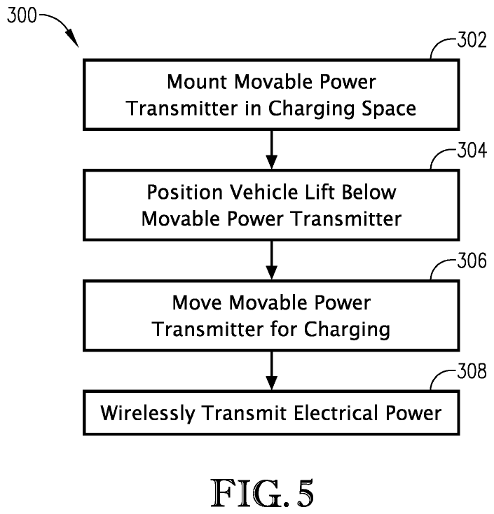

Given the description of the vehicle lift system 100 described above, embodiments of the present invention further include a method 300 for wirelessly providing power to vehicle lifts 102 of a vehicle lift system 100. As illustrated in FIG. 5, the method 300 may comprise a step of mounting a power transmitter 144 of a wireless charger 104 of a vehicle lift system 100 on a ceiling in a charging space 206, as shown in block 302. This may include attaching the power transmitter 144 to movable support 142 actuatable via a transmitter actuator 146.

The method 300 may further comprise a step of positioning a vehicle lift 102 within the charging space 206 below the power transmitter 144, as shown in block 304. This may include activating beacon 140 on the vehicle lift 102 so that beacon 140 transmits a locating signal.

The method 300 may further comprise a step of moving the power transmitter 144 from a first position to a second position, as shown in block 306. This may include the transmitter actuator 146 actuating the movable support 142. As described above, the first position may be a stowed position and the second position may be a deployed position. Further as described above, the first position may be a retracted position and the second position may be a downward extended position relative to the retracted position. In one embodiment, the transmitter actuator 146 may actuate the movable support and hence move the power transmitter 144 upon the power transmitter 144 receiving the locating signal. The power transmitter 144 may also be moved closer to the vehicle lift 102 (and/or the vehicle lift 102 may move closer to the power transmitter 144) based on the locating signal.

The method 300 may further comprise a step of wirelessly transmitting the electrical power via magnetic resonance from the power transmitter 144 to a power receiver 134 of the vehicle lift 102, as shown in block 308. This may include transmitting the electrical power downward, or focusing the electrical power downward toward the power receiver 134.

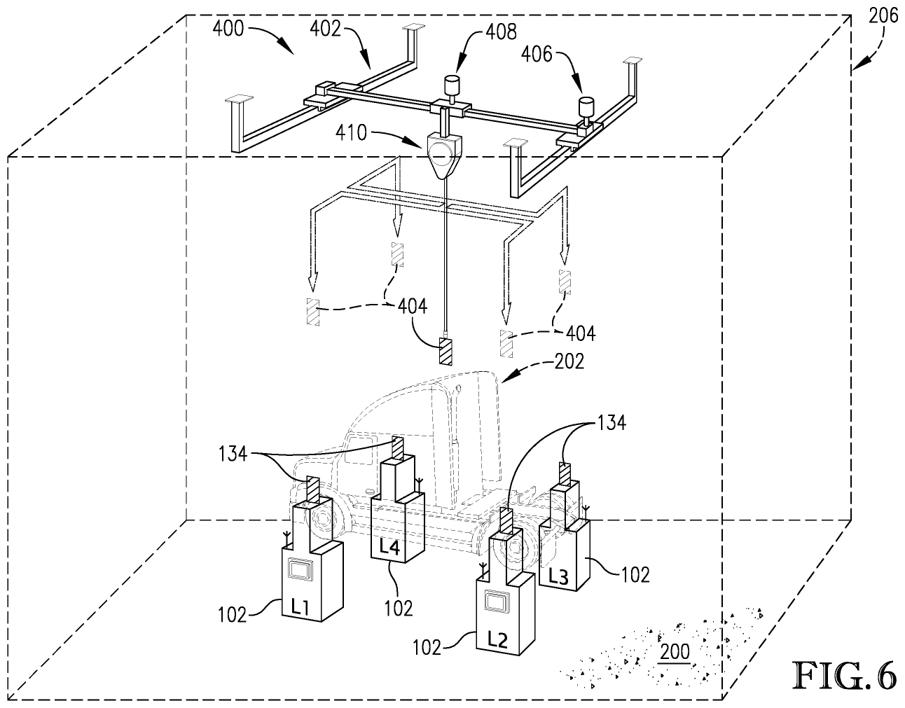

Turning to FIG. 6, a wireless charger 400 constructed in accordance with another embodiment of the invention is illustrated. The wireless charger 400 may broadly comprise a gantry system 402 and a power transmitter 404 mounted on the gantry system 402.

The gantry system 402 may include a first actuator 406 configured to move the power transmitter 404 in a first direction and a second actuator 408 configured to move the power transmitter 404 in a second direction. In one embodiment, the gantry system 402 may be an XY gantry system such that the first direction and the second direction are perpendicular to each other. In this way, the power transmitter 404 can be moved to any horizontal position within a service bay. The gantry system 402 may further include a third actuator 410 configured to move the power transmitter 404 in a Z (vertical) direction. In one embodiment, the gantry system 402 is an overhead crane.

The power transmitter 404 may be substantially similar to the power transmitter 404 described above. That is, The power transmitter 404 may be or may be part of a charging pad and may be connected to a power source, such as mains power. The power transmitter 404 may be configured to convert the electrical power from the power source into a time-varying electromagnetic wave. To that end, the power transmitter 404 may comprise a monopole antenna, a dipole antenna, or variations and/or combinations thereof. As specific examples, a monopole antenna may comprise metal rods, T antennas, inverted L antennas, umbrella antennas, or the like. A dipole antenna may include, for instance, a yagi-uda antenna, a log periodic antenna, a turnstile antenna, a corner reflector antenna, a patch antenna, or the like. In some embodiments, the power transmitter 404 may comprise a directional antenna (i.e., a high-gain antenna) configured to transmit electromagnetic waves over a relatively focused, narrow beam width. Such a directional antenna may comprise a parabolic antenna, a helical antenna, a yagi antenna, a phased array, and the like. The power transmitter 404 may further include simple structures such as conductive coils (i.e., loop antennas), a rectangular or circular plate, or the like. The power transmitter 404 may be particularly configured to transmit electrical power downward to a power receiver of a vehicle lift.

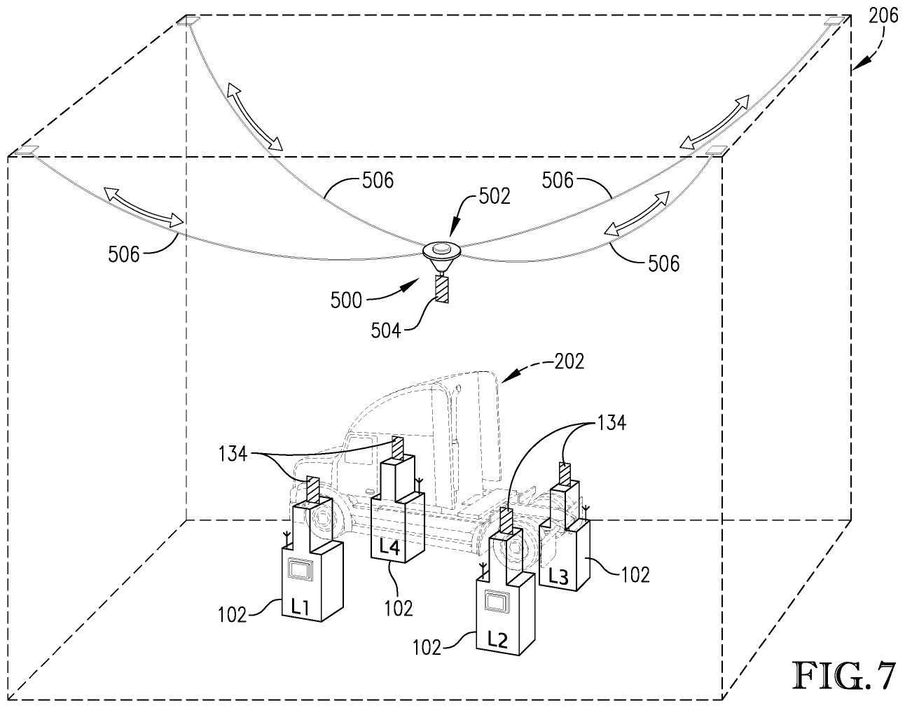

Turning to FIG. 7, a wireless charger 500 constructed in accordance with another embodiment of the invention is illustrated. The wireless charger 500 may broadly comprise a cable suspension system 502 and a power transmitter 504 mounted on the cable suspension system 502.

The cable suspension system 502 may include one or more cables 506 connected to the power transmitter 504. Each cable 506 may be configured to be selectively coiled on and uncoiled from a winch (not shown) so that uncoiling one of the cables 506 moves the power transmitter 504. Some of the cables 506 may be directly opposite each other so that coiling one cable 506 and uncoiling the opposite cable 506 moves the power transmitter 504 substantially in one direction in a horizontal plane. An additional pair of opposing cables 506 may be oriented orthogonally relative to the above-described opposing cables 506 so that coiling one cable and uncoiling the opposing cable 506 of the additional pair of cables 506 moves the power transmitter 504 substantially in a second direction perpendicular to the first direction in the horizontal plane. Furthermore, coiling more than one of the cables 506 may raise the power transmitter 504 in the Z direction and uncoiling more than one of the cables 506 may lower the power transmitter 504 in the Z direction.

The power transmitter 504 may be substantially similar to the power transmitters 144, 404 described above. That is, the power transmitter 504 may be or may be part of a charging pad and may be connected to a power source, such as mains power. The power transmitter 504 may be configured to convert the electrical power from the power source into a time-varying electromagnetic wave. To that end, the power transmitter 504 may comprise a monopole antenna, a dipole antenna, or variations and/or combinations thereof. As specific examples, a monopole antenna may comprise metal rods, T antennas, inverted L antennas, umbrella antennas, or the like. A dipole antenna may include, for instance, a yagi-uda antenna, a log periodic antenna, a turnstile antenna, a corner reflector antenna, a patch antenna, or the like. In some embodiments, the power transmitter 504 may comprise a directional antenna (i.e., a high-gain antenna) configured to transmit electromagnetic waves over a relatively focused, narrow beam width. Such a directional antenna may comprise a parabolic antenna, a helical antenna, a yagi antenna, a phased array, and the like. The power transmitter 504 may further include simple structures such as conductive coils (i.e., loop antennas), a rectangular or circular plate, or the like. The power transmitter 504 may be particularly configured to transmit electrical power downward to a power receiver of a vehicle lift.

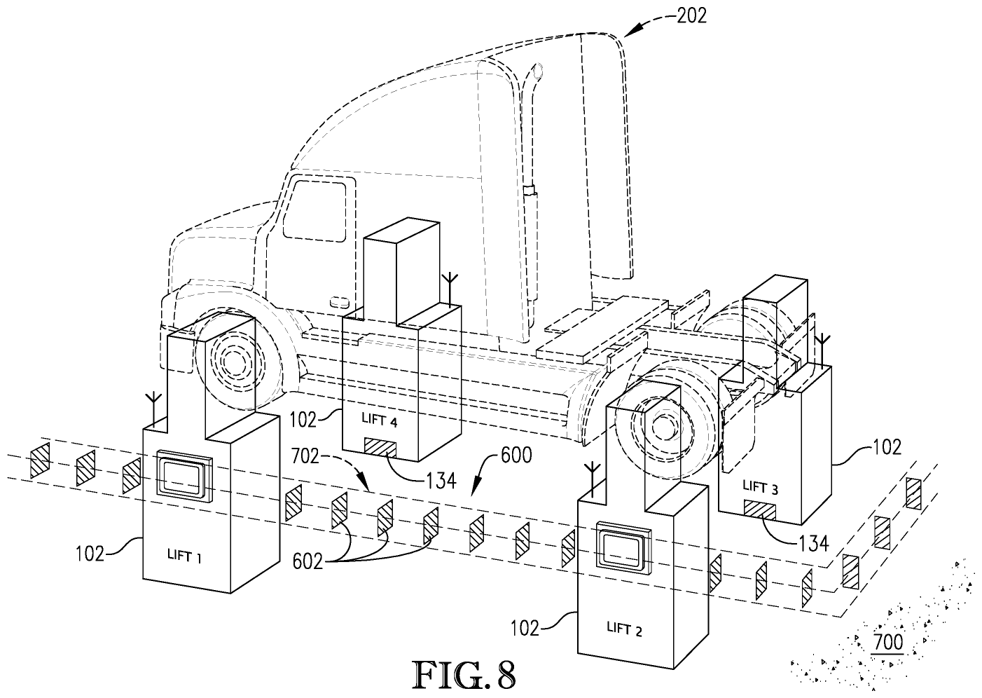

Turning to FIG. 8, a wireless charger 600 constructed in accordance with another embodiment of the invention is illustrated. The wireless charger 600 may broadly comprise a plurality of power transmitters 602 embedded in a floor 700. The power transmitters 602 may be centrally located so that vehicle lifts are moved to the power transmitters 602 to charge. If the vehicle lifts tend to be used in the same location, the power transmitters 602 may be embedded in the floor 700 where the vehicle lifts are used. In such a case, the vehicle lifts may be continuously or near-continuously charged while positioned on or near the power transmitters 602. In another embodiment, the power transmitters 602 may be centrally located, and vehicle lifts may move to the power transmitters 602 for charging. Multiple power transmitters 602 may be installed or one large power transmitter 602 capable of accommodating multiple vehicle lifts may be used. If the vehicle lifts are used in different locations, the power transmitters 602 may be embedded in a trench in the floor 700, such as along a length of a truck bay. To that end, the trench 702 may extend along a high-trafficked route or area so that vehicle lifts can be wirelessly charged by the power transmitters 600 as they traverse the floor 700 near the trench 702. This allows the vehicle lifts to be charged anywhere in a service bay regardless of a wheelbase of the vehicle being serviced.

The above-described wireless charger 600 may utilize resonant charging, which uses electromagnetic induction to transfer power. In addition to advantages described above, resonant charging allows power transmitters to be embedded below floor materials including concrete flooring. Furthermore, dirt, snow, ice, and other debris between a power transmitter and a power receiver will not affect charging performance.

The power transmitters 602 may be substantially similar to each other and thus only one power transmitter 602 will be described in detail. The power transmitter 602 may be similar to the power transmitters 144, 404, 504 described above. That is, the power transmitter 602 may be or may be part of a charging pad and may be connected to a power source, such as mains power. The power transmitter 602 may be configured to convert the electrical power from the power source into a time-varying electromagnetic wave. To that end, the power transmitter 602 may comprise a monopole antenna, a dipole antenna, or variations and/or combinations thereof. As specific examples, a monopole antenna may comprise metal rods, T antennas, inverted L antennas, umbrella antennas, or the like. A dipole antenna may include, for instance, a yagi-uda antenna, a log periodic antenna, a turnstile antenna, a corner reflector antenna, a patch antenna, or the like. In some embodiments, the power transmitter 602 may comprise a directional antenna (i.e., a high-gain antenna) configured to transmit electromagnetic waves over a relatively focused, narrow beam width. Such a directional antenna may comprise a parabolic antenna, a helical antenna, a yagi antenna, a phased array, and the like. The power transmitter 602 may further include simple structures such as conductive coils (i.e., loop antennas), a rectangular or circular plate, or the like. The power transmitter 602 may be particularly configured to transmit electrical power downward to a power receiver of a vehicle lift.

### ADDITIONAL CONSIDERATIONS

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, with the exception of the single, lift processor 62, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems or one or more hardware modules of a computer system (e.g., a processor) may be configured by software (e.g., an application or application portion) as computer hardware that operates to perform certain operations as described herein.

In various embodiments, computer hardware, such as a processing element or processor, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Software may accordingly configure the processing element to constitute a particular hardware configuration at one instance of time and to constitute a different hardware configuration at a different instance of time.

More generally, the processing elements or processors described herein may implement operating systems, and may be capable of executing computer programs, which are also generally known as instructions, commands, software code, executables, applications (“apps”), and the like. The memory elements may be capable of storing or retaining computer programs and may also store data, typically binary data, including text, databases, graphics, audio, video, combinations thereof, and the like. The memory elements may also be known as a non-transitory “computer-readable storage medium” and may include (unless otherwise specifically defined herein) random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules. Similarly, the methods or routines described herein may be at least partially processing element-implemented. For example, at least some of the operations of a method may be performed by one or more processing elements or processing element-implemented hardware modules.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, What is claimed as new and desired to be protected by Letters Patent includes the following:

1. A vehicle lift system comprising:
a vehicle lift comprising:
a base;
a carriage configured for receiving a wheel of a vehicle;
a lift actuator configured to vertically raise and lower said carriage relative to said base; and
a wireless charging system comprising:
a battery configured to provide electrical power to said vehicle lift; and
a power receiver electrically coupled with said battery; and
a wireless charger comprising:
a power transmitter configured to transmit electrical power to said power receiver via magnetic resonance, the power transmitter being movable between a first position and a second position for transmitting the electrical power in the second position.

2. The vehicle lift system of claim 1, wherein said power transmitter is ceiling-mounted and configured to transmit said electrical power downward toward the power receiver.

3. The vehicle lift system of claim 2, wherein said power receiver is positioned near a top of the vehicle lift for decreasing a transmitting distance between the power transmitter and the power receiver.

4. The vehicle lift system of claim 2, wherein said first position is a retracted position and said second position is a downward extended position relative to the retracted position so that the power transmitter is closer to the power receiver in the extended position than in the retracted position.

5. The vehicle lift system of claim 1, wherein said power transmitter is configured to automatically move between the first position and the second position.

6. The vehicle lift system of claim 5, wherein said power transmitter is configured to automatically move between the first position and the second position upon receiving a move signal from the power receiver.

7. The vehicle lift system of claim 6, wherein said power transmitter is configured to automatically move from the second position to the first position upon receiving the move signal, wherein the move signal indicates charging is complete.

8. The vehicle lift system of claim 1, wherein said power transmitter is configured to be manually moved between the first position and the second position.

9. The vehicle lift system of claim 1, wherein said wireless charger further comprises a gantry system configured to move the power transmitter between the first position and the second position.

10. The vehicle lift system of claim 1, wherein said wireless charger further comprises an overhead crane configured to move the power transmitter between the first position and the second position.

11. The vehicle lift system of claim 1, wherein said wireless charger further comprises a cable suspension system configured to move the power transmitter between the first position and the second position.

12. The vehicle lift system of claim 1, wherein said wireless charging system further comprises a beacon located on the vehicle lift and configured to transmit a locating signal, said power transmitter being configured to be moved from the first position to the second position based on the locating signal.

13. A vehicle lift system comprising:
a vehicle lift comprising:
a base configured to traverse a floor;
a carriage configured for receiving a wheel of a vehicle;
a lift actuator configured to vertically raise and lower said carriage relative to said base; and
a wireless charging system comprising:
a battery configured to provide electrical power to said vehicle lift; and
a power receiver electrically coupled with said battery; and
a wireless charger comprising:
a power transmitter embedded in the floor and configured to transmit electrical power to said power receiver via magnetic resonance upward through the floor.

14. The vehicle lift system of claim 13, wherein the wireless charger further comprises a plurality of power transmitters including said power transmitter, wherein said plurality of power transmitters are located in a trench in the floor.

15. A method of wirelessly providing power to a vehicle lift of a vehicle lift system, the method comprising steps of:
mounting a power transmitter of a wireless charger of the vehicle lift system on a ceiling in a charging space;
positioning the vehicle lift within the charging space below the power transmitter;
moving the power transmitter from a first position to a second position; and
wirelessly transmitting the electrical power via magnetic resonance from the power transmitter to a power receiver of the vehicle lift.

16. The method of claim 15, wherein said first position is a retracted position and said second position is a downward extended position relative to the retracted position such that said moving step includes moving the power transmitter closer to the power receiver.

17. The method of claim 15, wherein said moving step includes automatically moving the power transmitter between the first position and the second position.

18. The method of claim 15, wherein said moving step includes automatically moving the power transmitter between the first position and the second position upon receiving a move signal from the power receiver.

19. The method of claim 15, wherein said mounting step includes movably attaching said power transmitter to a gantry system, and wherein said moving step includes actuating the gantry system.

20. The method of claim 15, wherein said mounting step includes attaching said power transmitter to a cable suspension system, and wherein said moving step includes actuating the cable suspension system.
